(19) United States
(12) Patent Application Publication
(10) Pub. No.: US 2007/0205404 A1
(43) Pub. Date: Sep. 6, 2007

(54) Super carpet kicker

(76) Inventor: Vito Mancini, Manalapan, NJ (US)

Correspondence Address: Charles I. Brodsky, 2 Bucks Lane, Marlboro, NJ, 07746, US

(21) Appl. No.: 11/583,235

(22) Filed: Oct. 20, 2006

Related U.S. Application Data
(60) Provisional application No. 60/774,028, filed on Feb. 17, 2006.

(51) Int. Cl. B25B 25/00

(52) U.S. Cl. 254/201

(57) ABSTRACT

A kneeless kicking tool for stretching a carpet in which forward stroke of a reciprocable piston is actuated pneumatically from a source of compressed air.

### CROSS-REFERENCE TO RELATED APPLICATIONS

A Provisional Patent Application covering the invention described herein was filed Feb. 17, 2006, and assigned Ser. No. 60/774,028.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the installation of wall-to-wall carpeting and, more particularly, to a new and improved carpet kicker employed to snugly fit carpets into position.

2. Description of the Related Art

As is well known and understood, the installation of wall-to-wall carpeting often involves stretching the carpet to obtain a smooth, flat installation. As is also known, this generally entails installing tack strips around the perimeter of the area to be covered with the carpet adjacent to the walls of the area—and then rolling out the carpet into the room, usually over some padding, rough cut and seamed. One side of the carpet is then attached to the tack strip along one side of a room, and then stretched to the other side where the carpet is attached to an opposing tack strip. As will be understood, such process removes any wrinkles or creases in the carpeting, resulting in a flat, safe and visually appealing carpet installation.

As will be appreciated by those skilled in the art, during the above-described method of installing carpets, the carpet installer uses various tools for stretching the carpet—the most common being the carpet kicker which is typically constructed from an elongated rod having a head with a plurality of downwardly extending carpet gripping members at one end, and a knee pad at the other end. The elongated rod typically includes an offset bend adjacent to the head to provide clearance for the knee pad so that the head will be flat on the floor for maximum engagement with the carpet surface. The elongated rod is arranged to be parallel with the floor so as to transmit to the head the maximum force of a blow to the knee pad.

As is additionally well known and understood, carpet installers using such a device must get down on their hands and knees, use the carpet gripping head of the kicker to engage the carpet close to the edge to be stretched, and then kick the knee pad using a knee, thus stretching the carpet. The edge of the carpet is then pressed down onto the tack strip so as to secure the stretched carpet in place; any final trimming of the edge is then accomplished, and the edge is neatly tucked between the tack strip and the wall to give a finished appearance.

While these carpet kickers are extremely popular because they are relatively inexpensive and because they are particularly useful for stretching carpet in small areas, these type of carpet kickers have limited power for stretching carpet in larger areas. Additionally, these carpet kickers can be difficult to use for extended periods of time, due to the awkward posture which the installer must assume to use the device—and because the repeated blows to the knee pad, required for complete installation, can injure the knee. Besides being an operation which can be damaging to an installer's knee, possibly disabling the installer after a period of time, it is not unusual to find that this kind of operation can discourage the installer from continuing such strenuous and hazardous type of work to begin with.

### OBJECTS OF THE PRESENT INVENTION

It is an object of the present invention, therefore, to provide a new and improved carpet kicker construction which allows an easier operation in installing such wall-to-wall carpeting, and which permits a carpet installer to work comfortably for ever longer periods of time.

It is an object of the present invention, also, to provide such new and improved carpet kicker especially useful in the stretching of wall-to-carpeting in large floor areas.

It is a further object of the invention to provide a new and improved carpet kicker design which is less strenuous on an installer's knee when trying to force the carpeting to abut against the walls of a room in which the carpeting is being installed.

### SUMMARY OF THE INVENTION

As will be seen from the following description, the present invention relates to a kneeless kicking tool for stretching a carpet. In particular, a pneumatic system operates to do the work previously done by the knee in kicking to stretch the carpet—with the knee, in the present invention, just having to rest against the pneumatic kicker to hold it in place. As will become evident, the pneumatic tool system alone does all the work, saving the knee of the installer and permitting a continuous, less strenuous operation in getting the job done.

### BRIEF DESCRIPTION OF THE DRAWINGS

These and other features of the present invention will be more clearly understood from a consideration of the following description, taken in connection with the single FIGURE of the drawing, in which:

FIG. 1 is a pictorial view helpful in an understanding of the Super Carpet Kicker of the invention.

### DETAILED DESCRIPTION OF THE INVENTION

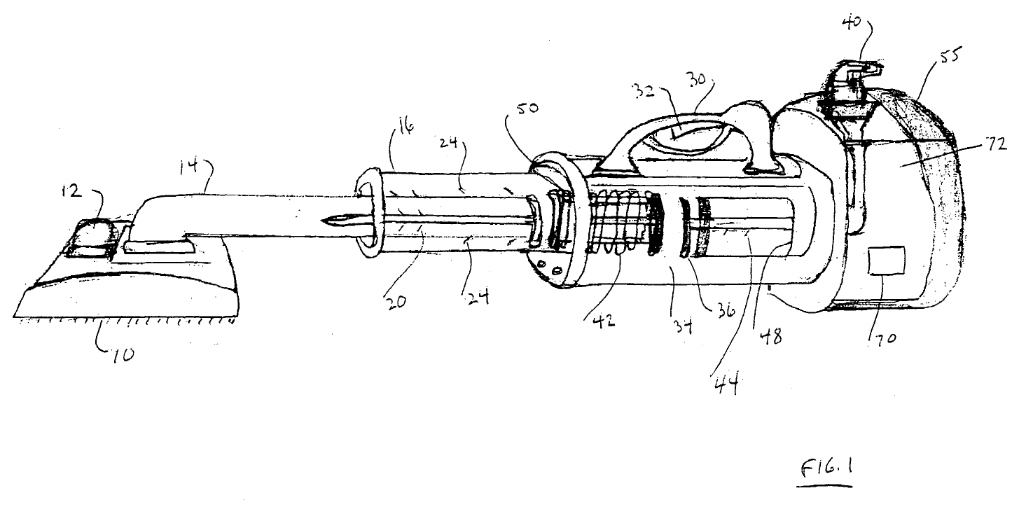

In the FIG. 1 embodiment, the standard carpet grabber is shown at 10, with its typical depth adjuster illustrated at 12. Reference numeral 14 represents the carpet kicker shaft which joins with the carpet grabber 10, and is arranged to slide forwardly and rearwardly within a sleeve housing 16. The housing 16 is grooved on its inside surface in an appropriate manner to guide forward and rearward reciprocating motion of the kicker shaft 14, which in turn is provided with outwardly extending pins as at 20 to fit within the grooves in restricting the shaft's actuation to be substantially linear only. A plurality of stopper pins 24 extend from the inside surfaces of the sleeve housing 16 to mate with similar extensions on the shaft 14 to limit the extent of any forward or rearward motion of the shaft 14 and carpet grabber 10. A handle 30 with a coordinated ON-OFF switch 32 joins with a chamber 34 in which a reciprocating piston 36 is enclosed for moving the carpet kicker of the invention about, and for energizing its use.

The reciprocating piston 36 is itself pneumatically controlled by compressed air either from a cylinder or from a compressor with a hose connection attached to it (not shown). The input for the piston is shown at 40 and serves to drive the piston in a right-to-left direction as shown in the drawing. A coil spring 42 surrounds the shaft 14 in the chamber 34 to provide retracted motion of the shaft 14 from left-to-right once the compressed air supply is shut down. A plurality of stopper pins 44 are provided to limit the piston's forward movement. An O-ring 48 about the piston 36 prevents any escape of compressed air from the chamber 34, and an air escape vent 50 is included to discharge to the outside that air in the chamber 34 moved by the right-to-left action of the actuated piston 36.

In use, the carpet installer rests his/her knee against an outside padding 55 on a cap 72 as a “rest”, and grasps the handle 30 to hold the carpet kicker in position so that the stretching can take place. However, by the piston movement pneumatically resulting from the compressed air, no need exists to repeatedly thump the knee forward against the padding 55 in moving the carpet grabber to stretch the carpet to the tack strip. The saving of the knee through wear-and-tear thus results. In instances, on the other hand, where the air supply may suddenly disconnect, or be used up in its entirety, a battery back up shown as 70 can be incorporated within the cap 72 to energize the piston for continued operation in reciprocating the kicker shaft 14 forwardly. The piston 36, in the nature of a ram, thus does all the work previously done by the installer's knee, but without the repeated driving of the knee to impel the shaft forward, and the possible injury which may result.

As will be understood, the advantages of the present invention will be readily apparent. In common, everyday use, a carpet installer uses his/her knee to kick and stretch and tuck the carpet in place. As they are kneeling, the installer kicks the end of the tool with the knee. After years of doing this, the installer typically comes down with bad knees, bad knee caps, water on the knee, or just a plain impairment of the joints—especially when the installer is working on both knees at the same time. With the present invention, on the other hand, the air is sent to the cylinder, the air hits the piston, and moves it forward to stretch the carpet—all without having to kick anything at all. Although padding is present at the end on the cap, it is only there as a rest for the knee to be placed up against it, and to hold the knee in place. As distinct from the carpet kickers of the prior art, here the tool alone does the work.

While there have been described what are considered to be preferred embodiments of the present invention, it will be readily appreciated by those skilled in the art that modifications can be made without departing from the scope of the teachings herein. For at least such reason, therefore, resort should be had to the claims appended hereto for a true understanding of the invention.

I claim:

1. A carpet kicker for stretching carpet towards a wall comprising:
a head member having a plurality of pins adjustably mounted for engaging said carpet;
a sleeve housing;
a chamber enclosing a reciprocable piston;
a shaft connected to said head member and extending rearwardly through said housing into said chamber;
means providing a source of compressed air for said chamber to pneumatically actuate said piston against said shaft in a forward stroke; and
spring means in said chamber surrounding said shaft to provide retracted rearward motion thereto when said source of compressed air is shut down.

2. The carpet kicker of claim 1 wherein said sleeve housing is grooved on an inside surface to guide forward and rearward reciprocating motion of said shaft substantially linearly.

3. The carpet kicker of claim 2, also including a plurality of stopper pins within said sleeve housing to limit the extent of forward and rearward motion of said shaft.

4. The carpet kicker of claim 3, also including a plurality of stopper pins within said chamber to limit the extent of forward stroke of said piston.

5. The carpet kicker of claim 4, including a handle with a coordinated ON-OFF switch on said chamber.

6. The carpet kicker of claim 5, also including an air escape vent on said chamber to discharge to the outside air in said chamber moved by the forward stroke of said piston.

7. The carpet kicker of claim 6, also including a knee pad rest on a rearward portion of said chamber.
